(19) United States
(12) Patent Application Publication
(10) Pub. No.: US 2016/0225000 A1
(43) Pub. Date: Aug. 4, 2016

(54) CONSENT VALUATION

(71) Applicant: AT&T Intellectual Property I, L.P., Atlanta, GA (US)

(72) Inventor: Jay O. Glasgow, Atlanta, GA (US)

(21) Appl. No.: 14/611,758

(22) Filed: Feb. 2, 2015

(51) Int. Cl. G06Q 30/02

(52) U.S. Cl. CPC G06Q 30/0203; G06Q 30/0207; G06Q 30/0257

(57) ABSTRACT

Methods, computer-readable storage media and apparatuses for consent management are disclosed. A processor stores a consent state for each personal data type of a plurality of personal data types of a user, determines a consent valuation based on the consent state of the each personal data type of the plurality of personal data types, and determines an action to be taken based on the consent valuation.

The present disclosure relates generally to communication networks and, more particularly, to methods, computer-readable media and devices for utilizing a consent valuation of a user.

### BACKGROUND

Consumers are becoming ever more protective of their personal data. For example, consumers are concerned with respect to identity theft and misuse of their personal data. However, although consumers are worried as to how their data will be used, consumers are nevertheless willing to provide consent to allow companies to use their personal data under certain scenarios, e.g., to receive product/services deem important to the consumers, e.g., geo-location information pertaining to the consumers may be required to provide services that are location based. In other words, consumers are generally willing to give consent to the use of their personal data to support the innate functionality of a particular subscribed service.

On the flip side, companies are interested in accessing consumers' data (i.e., big data) to provide better services and/or to promote new business opportunities (broadly “programs”). However, in order to use the consumers' personal data for any purpose other than which is required to support the innate functionality of a particular subscribed service, companies may be required to obtain consent from the consumers for such “programs.” This creates a tension between consumers who want to control how their personal data will be used and companies that want to access such big data to provide programs to the consumers.

### SUMMARY

In one example, the present disclosure discloses a method, computer-readable medium, and apparatus for consent management. For example, the method may include a processor storing a consent state for each personal data type of a plurality of personal data types of a user, determining a consent valuation based on the consent state of the each personal data type of the plurality of personal data types, and determining an action to be taken based on the consent valuation.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates an example of a consent relationship graph of a user in accordance with the present disclosure;

FIG. 3 illustrates a user interface showing a user's consent valuation and a list of personal data and their associated current consent state;

FIG. 4 illustrates a flowchart of a method for utilizing a consent value of a user in accordance with the present disclosure; and

FIG. 5 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses methods, computer-readable media and devices for generating and utilizing a consent valuation of a user. Although the present disclosure is discussed below in the context of wireless access networks and an Internet Protocol (IP) network, the present disclosure is not so limited. Namely, the present disclosure can be applied to packet switched or circuit switched networks in general, e.g., Voice over Internet Protocol (VoIP) networks, Service over Internet Protocol (SoIP) networks, Asynchronous Transfer Mode (ATM) networks, Frame Relay networks, and the like.

In one example, the present disclosure provides a consent management service for creating and utilizing a consent valuation of a user. It is often the case that consumers are requested to provide their consents to allow companies, e.g., service providers, manufacturers, retailers and the like, to utilize certain amount of their personal data in order to provide one or more innate functionalities. For example, a cellular service provider may request that a consumer consents to have his or her physical location information or data (broadly geo-location information) be used to provide the innate functionality of receiving cellular service. In other words, the cellular service provider must be able to determine the consumer's physical location in order to forward cellular calls to the consumer. Similarly, a mortgage company or a banking institution may request that a consumer consents to have his or her financial information or data be used and verified to receive the innate functionality of receiving a mortgage or a loan. In yet another example, a medical institution may request that a consumer consents to have his or her medical information or data be used and verified to receive the innate functionality of receiving a proper diagnosis of a potential ailment or disease. In yet another example, a media delivery service provider may request that a consumer consents to have his or her media viewing information or data be used and tracked to receive the innate functionality of receiving a notification of a future program that may be of interest to the consumer. In yet another example, a traffic notification service provider may request that a consumer consents to have his or her current location information or data be used and tracked to receive the innate functionality of receiving up to date traffic conditions on a route that the consumer is currently traveling on.

The above list of examples is only illustrative and not exhaustive. It is noted that consumers are becoming ever more protective of their personal data. For example, consumers are concerned with respect to identity theft and misuse of their personal data. However, as illustrated by the above examples, although consumers are worried as to how their data will be used, consumers are nevertheless willing to provide various consents to allow companies to use their personal data under certain scenarios, e.g., to receive product/services deem important to the consumers. In other words, consumers are generally willing to give consent to the use of their personal data to support the innate functionality of a particular subscribed service.

The above examples also illustrate another reality of the modern world that consumers are facing. The reality is that consumers are often requested to provide their consents in order to receive various services and/or products. Over a period of time, each consumer may have provided numerous consents for the use of various types of his or her personal data. For example, consents may be given in various contracts, applications or forms that are executed by consumers such as medical forms, financial forms, educational forms related to schools, employment forms related to job searches, housing applications related to rental property searches, online forms when online services are requested, online forms when software applications are downloaded, and so on. Again, the above list is only illustrative and not exhaustive. Thus, over a long period of time, each consumer may have very little knowledge as to what type of consents or the degree of consents that he or she has agreed to for the use of the consumer's personal data. In other words, management of the consumer's consent to the use of personal data is often lacking or non-existent.

On the flip side, companies are very interested in accessing consumers' data (i.e., big data) to provide better services and/or to promote new business opportunities (broadly “programs”). However, in order to use the consumers' personal data for any purpose other than which is required to support the innate functionality of a particular subscribed service, companies may be required to obtain additional consent from the consumers for such “programs.” For example, a company that has received a consumer's consent as to the use of the consumer's geo-location formation for providing cellular service may want to use the same consumer's geo-location formation to provide another service where the consumer's geo-location formation can be exploited, e.g., providing discount offers to a restaurant or a store that is located proximate to the consumer's current physical location. However, consumers may not be comfortable in providing consent to the use of their personal data outside of the innate functionalities of various subscribed services. This creates a tension between consumers who want to control how their personal data will be used and companies that want to access such big data to provide programs to the consumers.

In one embodiment of the present disclosure, a consent valuation is calculated for each user, e.g., a consumer of a product or a subscriber of a service. Once the consent valuation is calculated for each user, a service provider may utilize the calculated consent valuation to provide a reward or a subsidy to the user. Alternatively, the service provider may utilize the calculated consent valuation to offer a new program to the user.

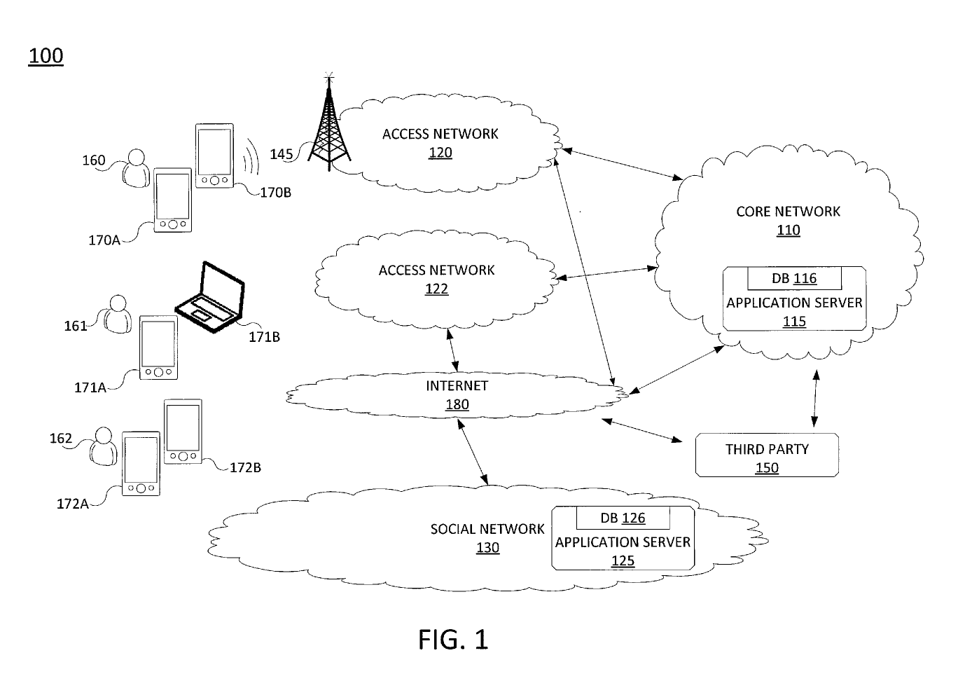

To aid in understanding the present disclosure, FIG. 1 illustrates a block diagram depicting one example of a communication network 100 suitable for performing or enabling the steps, functions, operations and/or features described herein. The overall communication network 100 may include any number of interconnected networks which may use the same or different communication technologies, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and so forth. It should be noted that an IP network is broadly defined as a network that uses Internet Protocol to exchange data packets.

As shown in FIG. 1, the communication network 100 connects endpoint devices 170A-172A and 170B-172B with each other and/or with one or more application servers via a core network 110, access networks 120 and 122, social network 130 and/or Internet 180. In one embodiment, core network 110, e.g., an IP network, interfaces with one or more of the access networks 120 and 122, and may also include interfaces to the Internet 180 and/or social network 130. Access network 120 may comprise a wireless access network (e.g., an IEEE 802.11/Wireless-Fidelity (Wi-Fi) network and the like) or a cellular access network, and may include a cellular base station and/or wireless access point 145. In one embodiment, access network 122 may comprise a PSTN access network, a cable access network, a wired access network and the like. In one embodiment, the access networks 120 and 122 and the core network 110 may be operated by different service providers, the same service provider or a combination thereof. Various interconnections between access networks 120 and 122, core network 110, Internet 180 and social network 130 are shown. In accordance with the present disclosure, it is contemplated that devices may utilize any one or a combination of such networks and interfaces in order to communicate with one another.

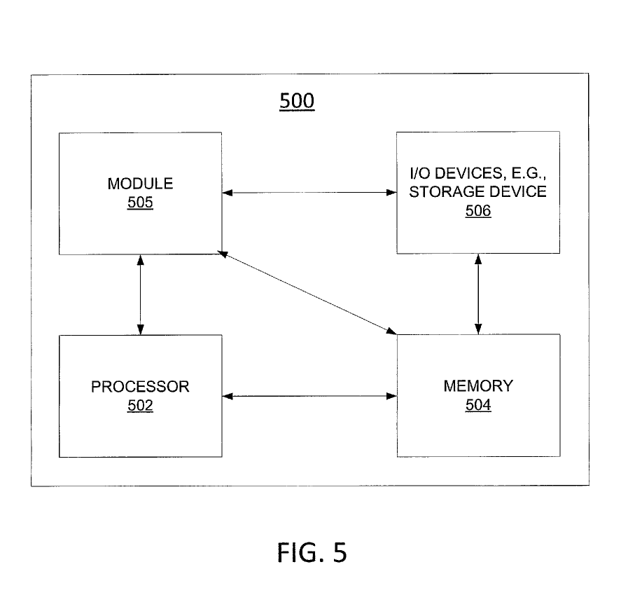

In one embodiment, the core network 110 may include an application server (AS) 115 and a database (DB) 116. Although only a single AS 115 and a single DB 116 are illustrated, it should be noted that any number of application servers 115 or databases 116 may be deployed. In one embodiment, the AS 115 may comprise a programmed computing device as illustrated in FIG. 5 and discussed below. In one embodiment, the AS 115 is configured to perform steps, functions and/or operations of a consent management service, e.g., for generating and utilizing a consent valuation for each user, accordance with the present disclosure. As such, DB 116 may store program code, data, files, and so forth to enable such functions. Thus, various embodiments are described herein as residing in or being performed in whole or in part by AS 115. For instance, AS 115 may calculate consent valuation for each of the users 160, 161, and 162 and then provides one or more additional services to the users 160, 161, and 162 based on the calculated consent valuation.

Social network 130 may also include an application server (AS) 125 and a database (DB) 126, which may be the same or similar to AS 115 and DB 116 in the core network 110 and which are also suitable to perform at least the same functions. Similarly, in another embodiment a stand-alone application server (not shown), e.g., connected to Internet 180, may perform the same or similar functions.

In one embodiment, each of endpoint devices 170A-172A and 170B-172B may comprise an endpoint device configured for wireless or wired communication such as a personal computer, a laptop computer, a Personal Digital Assistant (PDA), a mobile phone, a smart phone, an email device, a computing tablet, a messaging device, a computing pair of glasses, and the like. As illustrated in FIG. 1, endpoint devices 170A-172A and 170B-172B may belong to and/or be associated with users 160-162, respectively. In particular, each of users 160-162 may have multiple associated endpoint devices. For example, user 160 may have both a personal smart phone (e.g., endpoint device 170A) as well as a work smart phone assigned by an employer (e.g., endpoint device 170B). Similarly, user 161 may have both a mobile phone (e.g., endpoint device 171A) as well as a personal computer (e.g., endpoint device 170B). In addition, user 162 may also have a personal smart phone (e.g., endpoint device 172A) as well as a work smart phone assigned by an employer (e.g., endpoint device 172B).

Notably, one or more of the users 160-162 may be a subscriber of access network 120 and/or core network 110. Accordingly, in one embodiment DB 116 of AS 115 in core network 110 may store profile information of one or more of users 160-162, e.g., users who are also network subscribers. Taking user 160 as an example, the profile information stored in DB 116 may include a name, billing address, service address, telephone number and email address associated with user 160. The profile information may also include geographic location information regarding user 160. For example, location information may be determined from a source IP address associated with communications from user 160, global positioning system (GPS) information of a mobile device of the user, serving base station information, and so forth. The profile information stored in DB 116 may also comprise biographic information, e.g., age, memberships in various groups, professional associations, and so forth, as well as calendar information for the user 160. The profile may also include a contact list of the user 160 that may comprise various contacts in various categories including: friends, family, colleagues, sports team members, hobby group members, and so forth. Finally, the profile may also include consent information or data associated with the respective user.

Application server (AS) 115 may also access and/or store in DB 116 call detail records (CDRs) derived from telephone calls, emails, text messages, instant messages, multimedia messages (MMS), VoIP application usage, and the like which traverse various networks including core network 110, access networks 120 and 122, and so forth. Such CDRs may be gathered and accessed using any techniques which are well known in the art and may be used for various purposes in accordance with the present disclosure, as described in greater detail below. Furthermore, AS 115 may also have access to various other services that the user may have subscribed to. For example, the user may also have one or more subscriptions to a multimedia content delivery service, e.g., requesting movies to be streamed to the user, an Internet access service, a data delivery service, a health wellness monitoring service, a financial planning service, a banking service, an online product purchase service, a home monitoring service, a home or business security service, a remote network access service and so on. It should be noted that the above list of subscribed services is only illustrative, but is not intended to be exhaustive.

In turn, Application server (AS) 115 may also access and/or store in DB 116 the consents as to the use of the user's personal data in any one of the subscribed services. In other words, Application server (AS) 115 may serve as a centralized platform for storing the consents as to the use of the user's personal data. This allows the Application server (AS) 115 to calculate and leverage a user's consent valuation as discussed below. Furthermore, Application server (AS) 115 may also enhance the user's data experience in terms of consent management as discussed below.

In addition, each of the users 160-162 may participate in social networking via social network 130. Thus, each of the users 160-162 may have a social network profile that includes: posts and messages of the user, biographic information of the user, information on contacts of the user and/or other participants of the social network with whom the user has interacted, location/check-in information of the user, and so forth. In one example, the social network profiles of each of the users 160-162 may be stored in database (DB) 126 of application server (AS) 125. Collectively, the information stored in DB 126 may be referred to as social network information and may be used for determining a user's consent valuation.

For instance, application server (AS) 115 may access the social network information from AS 125/DB126 and use such information as an alternative to or in conjunction with service information and call detail record information available to AS 115 to automatically generate the user's consent valuation. For example, the user may have certain subscription to services that are provided or identified via the social network, which may further have associated consent information of the user. Such consent information of the user can be extracted from the social network by AS 115 and stored in the DB 116. Alternatively, consent information of the user can be extracted from the core network by AS 125 and stored in the DB 126. In other words, the functions or operations of the present disclosure can be deployed in the AS 125 of the social network as well.

FIG. 1 also shows a third party 150, which may be a service provider, e.g., a restaurant, a health club, a medical service provider, a bank, and the like, or a retailer or vendor for providing a product to the user, e.g., a department store, a supermarket, an online retailer and so on. It should be noted that although only one third party 150 is shown in FIG. 1 for clarity reasons, any number of third parties can be represented in FIG. 1.

Furthermore, it should be noted that the network 100 has been simplified. For example, the network 100 may include other network elements (not shown) such as border elements, routers, switches, policy servers, security devices, gateways, a content distribution network (CDN), firewalls, and the like. Thus, FIG. 1 is only intended to illustrate one exemplary environment in which embodiments of the present disclosure may be employed.

In one embodiment, the user provides consent to the use of one or more personal data. Personal data may comprise: 1) geo-location information, e.g., the current physical location of the user, 2) multimedia content consumption information, e.g., the type of content such as movies and/or programs watched by the user, 3) viewing schedule information, e.g., time schedule that the user is watching the content, e.g., 9:00 pm on a Sunday and so on, 4) medication information, e.g., medication purchased by the user, 5) medical information, e.g., medical conditions associated with the user, 6) delivery of product information, e.g., the time and day that a product is delivered to the user, 7) financial information, e.g., banking information, mortgage information, credit information, credit card information and the like, 8) biometric information, e.g., the current body temperature of the user, the current weight of the user, the current shoe size of the user, the current height of the user, and the like, 9) appointment information of the user, e.g., events on a calendar of the user, 10) communication information, e.g., individuals that the user has communicated with via phone calls, emails, text messages, and the like, and 11) contact information, e.g., phone numbers of contacts (e.g., friends, family and co-workers), email addresses of contacts, home addresses of contacts, and so on. Again, this list of personal data is only illustrative and should not be deemed to be an exhaustive list. Given the need of the innate functionality of a subscribed service of the purchase of a product, a user may have to provide consent to the use of one or more of the above list of personal data.

For example, purchasing a product online may require the user to provide consent as to the use of: 1) the user's credit card information to complete the transaction, and 2) the user's email address to receive product delivery tracking information, e.g., a tracking number of a delivery service. In another example, purchasing a medical boot may require the user to provide consent as to the use of: 1) the user's medical records to ascertain the prescription for the purchase of the medical boot, and 2) the user's biometric information such as the size of the user's foot so that a properly sized medical boot can be determined. Such consents are often freely provided by the users since they pertain to the innate functionalities of the provided services.

However, the personal data provided in the above examples can be leveraged to provide other programs. For example, the user's credit card information and the user's email address can be used and tracked by a fraud detection program. For example, if the user's email address has been flagged as a potential email address associated with a credit card theft ring, then the online transaction can be flagged as a potentially unauthorized use of the user's credit card. However, if the user did not provide his or her consent, the fraud detection program's use of such personal data may be prohibited. Thus, there is an incentive for the service provider of the fraud detection program to gain the necessary consent(s) from the user so that the fraud detection program can be offered to the user or to the credit card company that issued the credit card to the user. The user may also have an incentive in that the fraud detection program may protect the credit rating of the user and may also minimize a financial loss to the user by quickly detecting the credit card fraud.

Similarly in the other example, the user's medical records and the user's biometric information can be used by a health wellness monitoring program of a health insurance company. For example, the health insurance company has an interest in knowing the degree of injury suffered by the user (who may be insured by the health insurance company) and that the user is receiving the proper medical treatment and purchasing the proper medical devices to ensure a speedy recovery. However, if the user did not provide his or her consent, the health wellness monitoring program's use of such personal data may be prohibited. Again, there is an incentive for the service provider of the health wellness monitoring program to gain the necessary consent(s) from the user so that the health wellness monitoring program can be offered to the user. The user may also have an incentive in that the health wellness monitoring program may provide additional services that the user may not be aware of, e.g., additional medical coverage, travel re-imbursement and the like.

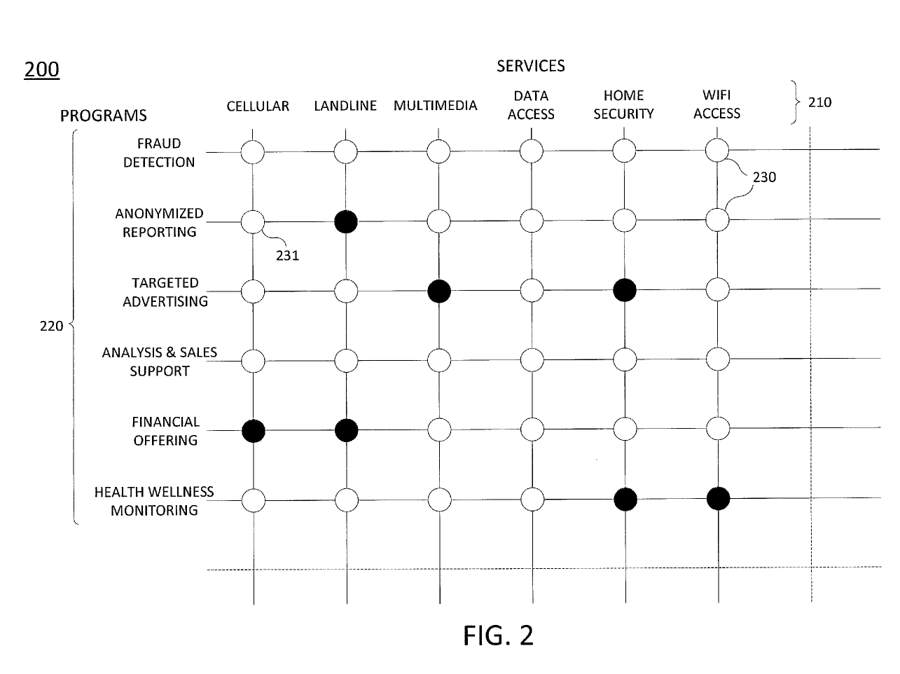

FIG. 2 illustrates an example of a consent relationship graph or array 200 of a user in accordance with the present disclosure. In one embodiment, the present disclosure provides a system that has a centralized platform (e.g., an application server) for managing consents to use personal data from consumers across a wide array of services 210. As part of this management, the platform maintains a consent array 200 or consent aggregation to provide an efficient architecture to store and to monitor consumer consents.

In one illustrative embodiment, a grid 200 comprises services 210 as vertical lines running up and down and programs 220 as horizontal lines running back and forth is illustrated. Each intersection 230 of the vertical line and horizontal line will contain a consent choice that is made by a consumer. For example, an “unfilled” intersection will indicate that the consumer has given “informed” consent, e.g., when a consumer signs up for a service and the contract indicates that the consumer hereby gives consent for the collection and use of his or her personal data for one or more programs. If the intersection is filled with a green color, then it indicates that the consumer has opted-in to the program (i.e., actively provided consent). On the other hand, if the intersection is filled with a red color, then it indicates that the consumer has opted-out of the program (i.e., actively withheld consent). This consent array can be easily coded and is extremely scalable. Such arrays allow consumer consent data to be easily stored, retrieved and aggregated to enforce consent elections of the consumers. For example, the consent array for a large number of consumers can be stored on a single platform to promote ease of consent enforcement. It should be noted that the color coded scheme is only illustrative and should not be interpreted as a limitation of the present disclosure. Any number of other colors, symbols and/or geometric shapes can be used to represent the various types of consent.

The above described consent array 200 provides several advantages. First, the uniformity of the consent array 200 allows the sharing of consumer consent data with different companies in a consistent manner (i.e., consent federation). Second, properties of the services and the programs can be analyzed to determine a consent pattern for each consumer. Properties may include: 1) data affected by the consent (e.g., types of consumer data, e.g., location, consumption of goods and services, health, etc., 2) trigger associated with the consent, e.g., a payment event, a provisioning event, a notification event, etc., 3) consent tier (e.g., at a user level, at an account level, at a device level, etc.), and 4) communication channel (e.g., text, email, verbal, written, second-party, etc.). Using the properties identified above, companies will be able to deduce the type of programs that a consumer will likely be willing to join. Furthermore, using the properties identified above, consumers can be made aware of their patterns of consent that will allow the consumers to manage their patterns of consent, e.g., changing their consent patterns and/or simplifying future consent elections, i.e., the consumers can make a more informed consent election given that the consent pattern will reveal to the consumers as to what the consumers have already consented to in the past.

Finally, the consent array 200 of a particular consumer can be viewed as the consent DNA or consent signature of a consumer. Such consent DNA or consent signature can then be correlated with historical consent DNA or consent signature data to make a prediction for a particular consumer. For example, if the consent signature of a consumer matches a particular pattern and that pattern indicates historically that consumers with that consent signature is prone to subscribe to certain services and/or to purchase certain products, then these services and products can be directed to this particular consumer. Namely, by recognizing the consent signatures, inferences can then be made based on the consent signatures. Such inferences may lead to certain actions to be performed. These further actions may include, but are not limited to, offering advantageous pricing on existing products or services, targeting new products/services to certain customers first based on their consent signatures, and providing the data to third parties for their use in providing targeted advertising or marketing of various products/services.

FIG. 2 illustrates a plurality of services 210 that a user may subscribe to such as: 1) cellular service, 2) land line telephony service, 3) multimedia delivery service, 4) data access service, e.g., Internet access service, 5) home security service , and 6) Wi-Fi access service, and so on. FIG. 2 also illustrates a plurality of programs 220 that may be offered to the user such as: 1) fraud detection program, 2) anonymized reporting program, e.g., gathering and reporting statistics on the viewing preferences of the user, statistics on purchasing habits of the user, statistics on geo-location coordinates and so on, 3) targeted advertising program, e.g., third party providing targeted advertising to the users, 4) analysis and sales support program, e.g., third party analyzing sales associated with its own products and the need to provide support to the users, 5) financial offering program, and 6) health wellness monitoring program, and so on. Again the above lists of services and programs are only illustrative and are not exhaustive. Furthermore, the term “service” and “program” may be used interchangeably.

In one embodiment, a consent valuation can be calculated for a user. To illustrate, if the user is a cellular service subscriber and has opted-in to allow the user's geo-location information to be used by the anonymized reporting program (shown by intersection 231), then the anonymized reporting program can utilize this user's geo-location information for its own use. If the anonymized reporting program is a traffic reporting program, then the user's geo-location information (e.g., extracted from the user's mobile cellular endpoint device) can be aggregated with other users' geo-location information to provide a comprehensive view as to the local traffic condition. For example, the anonymized reporting program may deduce that the user is traveling approximately 40 mph, thereby concluding that the user is likely traveling in a vehicle. The anonymized reporting program may then correlate the user's geo-location information continuously onto a roadway, thereby concluding that the current traffic on that particular roadway must be moving approximately 40 mph. Thus, by using the user's geo-location information, the anonymized reporting program is now able to provide a real-time traffic condition service that it otherwise would not be able to provide with such accuracy. If the anonymized reporting program charges $1.00/month to each of its own subscribers for this real-time traffic reporting service, the service provider of the anonymized reporting program may be willing to share this monthly charge with the cellular service provider that originally provided the real time geo-location information associated with its subscribers. In sum, the cellular service provider has now derived real monetary value based on its subscribers' willingness to allow their geo-location information to be used outside of the innate functionality of receiving cellular services.

In one embodiment, the cellular service provider is able to quantify the real monetary value that is attributable to each individual user. For example, if the cellular service provider provided geo-location information from 1 million subscribers who have provided their consent, and received a monetary payment of $100,000, then it can be correlated that each subscriber's geo-location information is responsible for a value of 10 cents (minus any cost that may be incurred in providing the geo-location information to the anonymized reporting program). However, each user may have provided additional consents to other programs. If these other programs are also generating monetary values, then each subscriber's personal data may be responsible for additional monetary values. By adding these different monetary values, a “consent valuation” can be calculated for each user.

In general, the more consents that a user is willing to provide, the higher the user's consent valuation. In one embodiment, the service provider(s) of the services 210 may be willing to provide a reward or a subsidy back to the users as an incentive or benefit in providing their consents in allowing their personal data to be used in other context outside of the innate functionalities of their subscribed services. The reward or subsidy may take the form of a monetary reward, e.g., a reduction in the user's monthly bill for a subscribed service, a rebate check or other non-monetary rewards such as a higher bandwidth for a subscribed service, reward points to acquire other services or media content (e.g., movies, videos, songs, and/or electronic books) for free, and so on.

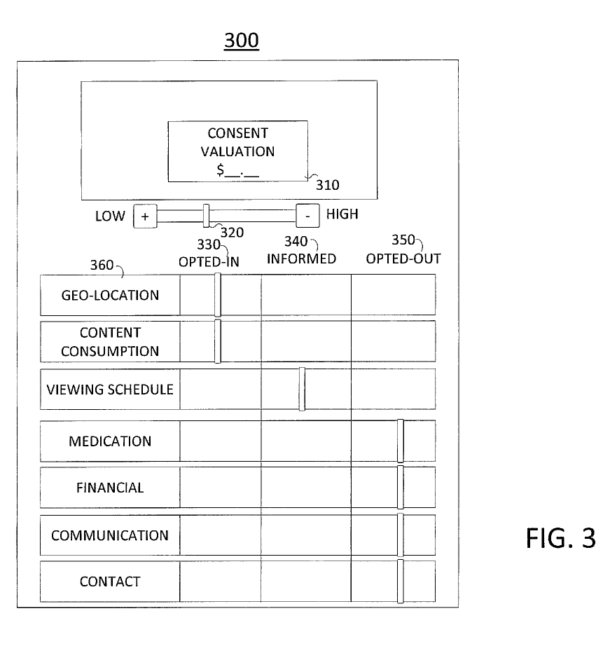

FIG. 3 illustrates a user interface or screen 300 showing a user's consent valuation 310 and a list of personal data fields or types 360 and their associated current consent state 330-350. As discussed above, management of a user's consents to the use of various personal data is often lacking or non-existent. FIG. 3 shows a user interface 300 that will enhance a user's data experience by providing a concise and clear picture as to what type of personal data that the user has consented to being used outside of an innate functionality. For example, FIG. 3 illustrates that for this particular user, the user has consented (opted-in consent column 330) for his geo-location information and multimedia content consumption information to be used. In contrast, the user has not consented (opted-out consent column 350) for his medication information, financial information, communication information and contact information to be used. Finally, FIG. 3 illustrates that the user has been informed (informed consent column 340) that his content viewing schedule information will be used by other programs. The user interface or screen 300 will greatly enhance the user experience because the user is able to quickly deduce the various consent state for each individual type of personal data.

Furthermore, FIG. 3 illustrates a current consent valuation 310 (e.g., expressed in some dollar value) that will indicate to the user as to the current value that he or she has been able to derive based purely on providing one or more consents for the use of his or her personal data. It should be noted that the current consent valuation can be expressed in other units of measure aside from dollar value, e.g., a ranking score within a predefined range of scores, e.g., 1-100. FIG. 3 also illustrates a sliding bar 320 to show the user his or her consent valuation as compared to a larger pool of users. In other words, the calculated consent valuation for each user is compared to a total pool of users and is reflected in the positioning of the sliding bar 320. If the user's consent valuation is relatively low, then the sliding bar 320 is positioned toward the left side, whereas if the user's consent valuation is relatively high, then the sliding bar 320 is positioned toward the right side.

In one embodiment, if the user wishes to change the consent state for a particular type of personal data, the user may simply grab and move one of the pertinent sliding bar associated with that particular personal data to a different consent state. The system will then record the change in consent state for that particular personal data and quickly provide a notification to the affected service or program. In turn, the consent valuation 310 may reflect a change in its value depending on the change, e.g., increasing in value when additional consents are given, or decreasing in value when consents are retracted. However, there may be instances where a change in the consent state for a particular type of personal data may have no impact on the overall consent valuation, e.g., if the type of personal data experiencing the change in consent state is actually not contributing to the user's current consent valuation.

In one embodiment, the user may simply shift the sliding bar 320 to see a change in the consent valuation 310, e.g., sliding the sliding bar 320 to the right should produce a higher consent valuation 310, and vice versa. Furthermore, the system may even propose changes to the consent state of one or more personal data fields 360 depending on how aggressive the user is sliding the sliding bar 320. For example, sliding the sliding bar 320 all the way to the right may cause the sliding bars of all personal data fields 360 to slide to the left, i.e., showing the user that he or she must now opt-in for all personal data fields to bring about the projected consent valuation. In one embodiment, the sliding bars of the personal data fields 360 do not automatically move, but may simply flash or change color to show the user that these sliding bars need to be moved manually to bring about the projected consent valuation.

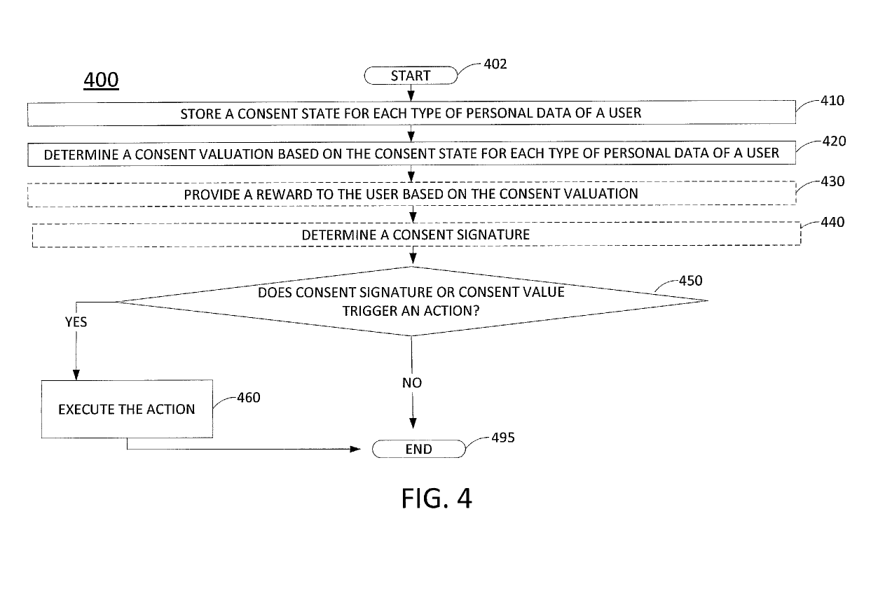

FIG. 4 illustrates a flowchart of a method 400 for utilizing a consent valuation of a user in accordance with the present disclosure. In one embodiment, steps, functions and/or operations of the method 400 may be performed by a network-based device, e.g., application server 115 or application server 125, in FIG. 1. In another embodiment, steps, functions and/or operations of the method 400 may be performed by a user endpoint device, e.g., endpoint device 170A or 170B in FIG. 1, or by a network-based device in conjunction with a user endpoint device. In one embodiment, the steps, functions, or operations of method 400 may be performed by a computing device or system 500, and/or processor 502 as described in connection with FIG. 5 below. For illustrative purpose, the method 400 is described in greater detail below in connection with an embodiment performed by a processor, such as processor 502. The method begins in step 402 and proceeds to step 410.

At step 410, the processor stores a consent state for each type of personal data of a user. For example, the user may have elected to either opt-in or to opt-out of providing a consent for an associated type of personal data for a particular program. Alternatively, the consent may take the form of an informed consent. Thus, the consent array 200 may be populated with inputs provided by the user and the consent state associated with each type of personal data is stored in a database, e.g., DB 116 or DB 126.

At step 420, the processor determines a consent valuation for the user based on the consents provided by the user. In one embodiment, the service provider, e.g., of the services 210 of FIG. 2 is able to quantify the real monetary value that is attributable to each individual user based on his or her given consents for each program. By adding monetary values derived from the pertinent programs, a “consent valuation” can be calculated for each user.

At optional step 430, the processor may optionally provide a reward or a subsidy to the user based on the calculated consent valuation. For example, if a user's “consent valuation” is $20, then a reward amount of $4 can be credited to the user's bill. Alternatively, a non-monetary reward can be provided to the user, e.g., providing a greater bandwidth for a subscribed service, free minutes on a cellular service or a long distance service, free access to download a movie, a television program, a sports program or a song, providing an opportunity to upgrade a mobile phone or smartphone, providing a priority to access new products and services before other subscribers, and so on.

At optional step 440, the processor optional determines a consent signature for the user. For example, as illustrated in FIG. 3, the plurality of types or fields of personal data along with their consent states form a consent signature of the user. As discussed above, this consent signature may change over time.

At step 450, the processor determines whether the consent valuation and/or the consent signature will trigger an action. For example, if the consent valuation exceeds a threshold that is set for a program, then the processor may send an offer to the user for subscribing to the program. For example, if the consent valuation is particularly high, then the service provider may suggest that the user subscribes to an identity theft monitoring program, since there are many services and programs currently using the user's personal data. One fear is that if any one of these services or programs is hacked, then the user's personal data may be accessed by malicious entities. Thus, a subscription to the identity theft monitoring program may be prudent.

Alternatively, if the consent signature matches a particular consent pattern, then the processor may take an action that is predictive of the particular consent pattern. For example, through an analysis of historical data where users with a similar consent signature had purchased a particular product or subscribed to a particular service, then the processor will offer such product or such service to the current user. In other words, the consent signature of the user by itself can be used as a prediction tool to determine the user's likely behavior toward a product or a service. If the answer is positive at step 450, the processor will proceed to step 460 to execute the pertinent action, e.g., offering a product or a service to the user. If the answer is negative at step 450, the processor will proceed to step 495 where method 400 ends.

It should be noted that although not specifically specified, one or more steps, functions or operations of the method 400 may include a storing, displaying and/or outputting step as required for a particular application. In other words, any data, records, fields, and/or intermediate results discussed in the respective methods can be stored, displayed and/or outputted to another device as required for a particular application. Furthermore, steps or blocks in FIG. 4 that recite a determining operation or involve a decision do not necessarily require that both branches of the determining operation be practiced. In other words, one of the branches of the determining operation can be deemed as an optional step. In addition, one or more steps, blocks, functions or operations of the above described method 400 may comprise optional steps, or can be combined, separated, and/or performed in a different order from that described above, without departing from the example embodiments of the present disclosure.

As such, the present disclosure provides at least one advancement in the technical field of consent management. This advancement allows for a system to quantify a consent valuation and a consent signature attributable to the user. In turn, the consent valuation and the consent signature can be used to enhance the user's experience. In fact, the consent valuation and the consent signature can be used to promote new products and services to the user. The present disclosure also provides a transformation of data. For example, consent information is transformed into valuation information and signature information that can be used as a prediction of the user's behavior.

Finally, embodiments of the present disclosure improve the functioning of a computing device, e.g., a server and/or a user endpoint device. Namely, a server or endpoint device dedicated for providing consent management services is improved.

FIG. 5 depicts a high-level block diagram of a computing device suitable for use in performing the functions described herein. As depicted in FIG. 5, the system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for utilizing a consent valuation, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 400 as discussed above is implemented in a distributed or parallel manner for a particular illustrative example, i.e., the steps of the above method 400, or the entire method 400 is implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 400. In one embodiment, instructions and data for the present module or process 505 for utilizing a consent valuation (e.g., a software program comprising computer-executable instructions) can be loaded into memory 504 and executed by hardware processor element 502 to implement the steps, functions or operations as discussed above in connection with the illustrative method 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for utilizing a consent valuation (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method, comprising:
storing, by a processor, a consent state for each personal data type of a plurality of personal data types of a user;
determining, by the processor, a consent valuation based on the consent state of each personal data type of the plurality of personal data types; and
determining, by the processor, an action to be taken based on the consent valuation.

2. The method of claim 1, further comprising:
providing, by the processor, a reward to the user based on the consent valuation.

3. The method of claim 2, wherein the reward comprises a monetary reward.

4. The method of claim 2, wherein the reward comprises a non-monetary reward.

5. The method of claim 1, further comprising:
determining, by the processor, a consent signature based on the consent state of the each personal data type of the plurality of personal data types.

6. The method of claim 5, wherein the action to be taken is further based on the consent signature.

7. The method of claim 1, wherein the action to be taken comprises an offer for a product.

8. The method of claim 1, wherein the action to be taken comprises an offer for a service.

9. A tangible computer-readable storage medium storing instructions which, when executed by a processor, cause the processor to perform operations, the operations comprising:
storing a consent state for each personal data type of a plurality of personal data types of a user;
determining a consent valuation based on the consent state of each personal data type of the plurality of personal data types; and
determining an action to be taken based on the consent valuation.

10. The tangible computer-readable storage medium of claim 9, further comprising:
providing a reward to the user based on the consent valuation.

11. The tangible computer-readable storage medium of claim 10, wherein the reward comprises a monetary reward.

12. The tangible computer-readable storage medium of claim 10, wherein the reward comprises a non-monetary reward.

13. The tangible computer-readable storage medium of claim 9, further comprising:
determining a consent signature based on the consent state of the each personal data type of the plurality of personal data types.

14. The tangible computer-readable storage medium of claim 13, wherein the action to be taken is based on the consent signature.

15. The tangible computer-readable storage medium of claim 9, wherein the action to be taken comprises an offer for a product.

16. The tangible computer-readable storage medium of claim 9, wherein the action to be taken comprises an offer for a service.

17. A device, comprising:
a processor; and
a computer-readable medium storing instructions which, when executed by the processor, cause the processor to perform operations, the operations comprising:
storing a consent state for each personal data type of a plurality of personal data types of a user;
determining a consent valuation based on the consent state of each personal data type of the plurality of personal data types; and
determining an action to be taken based on the consent valuation.

18. The device of claim 17, further comprising:
providing a reward to the user based on the consent valuation.

19. The device of claim 17, further comprising:
determining a consent signature based on the consent state of the each personal data type of the plurality of personal data types.

20. The device of claim 19, wherein the action to be taken is further based on the consent signature.
